(19) United States
(12) Patent Application Publication
(10) Pub. No.: US 2026/0328236 A1
(43) Pub. Date: Oct. 22, 2026

(54) COUPLING SYSTEM

(71) Applicant: Shibumi Shade, Inc., Raleigh, NC (US)

(72) Inventors: Brent Carlson, Bountiful, UT (US); Tyler Westbroek, Clearfield, UT (US)

(21) Appl. No.: 19/647,492

(22) Filed: Apr. 14, 2026

Related U.S. Application Data
(60) Provisional application No. 63/790,265, filed on Apr. 17, 2025.

(51) Int. Cl. F16B 7/04

(52) U.S. Cl. CPC F16B 7/0433

(57) ABSTRACT

A coupling system is disclosed herein and includes a first component and a second component each including a top surface, a body portion defined by a body wall having two opposing sides and two opposing ends and extending from the top surface to a bottom surface opposing the top surface, a channel formed through the two opposing ends of the body wall and between the top surface and the bottom surface, and a coupling mechanism. The first component being coupleable with a first product receivable in the first component's channel and the second component being coupleable with a second product receivable in the second component's channel, the first component and the second component being brought into removable engagement by coupling the coupling mechanisms together so as to enable the first and second products to be transported together as a unit.

### TECHNOLOGICAL FIELD

The presently disclosed subject matter is directed towards a coupling system; and more particularly to a coupling system that enables removable engagement of two products, such as foldable chairs, to enable transport of the two products together as a unit.

### BACKGROUND

The ability to easily collapse and transport a chair (and ideally more than one at a time) is desirable in many use applications; including, for example, camping, sporting events, tailgating, traveling, going to the beach, etc. For this reason, a foldable chair must have the ability to perform well in two main configurations-a transport configuration and a supporting configuration. In the transport configuration, such chairs are typically awkward, heavy, and/or bulky making transport of more than one chair at a time difficult.

In this way, there remains a need for a system for transporting more than one foldable chair that allows for easy engagement of the foldable chairs, comfortable transport of the foldable chairs as a unit, and then easy disengagement of the foldable chairs for use. Such a system is needed that is lightweight, rugged, and easily stored when not in use.

### BRIEF SUMMARY

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed disclosure, in any of its various aspects and embodiments, should be viewed as intended to be combinable unless the context clearly dictates otherwise. Example embodiments are set forth as follows:

A first example embodiment comprising a coupling system comprising: a first component comprising a first top surface and a first body portion defined by a body wall having two opposing sides and two opposing ends and extending from the first top surface to a first bottom surface opposing the first top surface, wherein a first channel is formed through the two opposing ends of the body wall of the first body portion and between the first top surface and the first bottom surface, the first component comprising a first coupling mechanism; a second component comprising a second top surface and a second body portion defined by a body wall having two opposing sides and two opposing ends and extending from the second top surface to a second bottom surface opposing the second top surface, wherein a second channel is formed through the two opposing ends of the body wall of the second body portion and between the second top surface and the second bottom surface, the second component comprising a second coupling mechanism complementary to the first coupling mechanism; wherein the first component is coupleable with a first product receivable in the first channel and the second component is coupleable with a second product receivable in the second channel, the first component and the second component being brought into removable engagement by coupling the first and second coupling mechanisms together so as to enable the first and second products to be transported together as a unit.

The example embodiment of the coupling system of any preceding example embodiment or any combinations of preceding example embodiments, wherein the first coupling mechanism comprises a first magnet arranged within the first body portion and adjacent to the first top surface, and the second coupling mechanism comprises a second magnet arranged within the second body portion and adjacent to the second top surface, such that the first coupling mechanism and the second coupling mechanism are brought into removable engagement by magnetically coupling the first magnet of the first coupling mechanism and the second magnet of the second coupling mechanism so as to enable the first and second products to be transported together as the unit.

The example embodiment of the coupling system of any preceding example embodiment or any combinations of preceding example embodiments, wherein the first coupling mechanism further comprises a first protrusion defining a first central axis and extending from the first top surface to a first protrusion surface with a circumferentially extending side wall arranged between the first top surface and the first protrusion surface, the first protrusion defining a cavity having an a extending radially outwardly from the first central axis and through a portion of the side wall and a portion of the first protrusion surface, the first magnet being coaxially aligned in the first body portion of the first component with the first central axis of the first protrusion and with a first polarity facing the first top surface, wherein the second coupling mechanism further comprises a second protrusion defining a second central axis and extending from the second top surface to a second protrusion surface with a circumferentially extending side wall arranged between the second top surface and the second protrusion surface, the magnet of the second polarity being coaxially aligned in the second body portion of the second component with the second central axis of the second protrusion and with a second polarity opposite to the first polarity facing second top surface, and wherein the first component and the second component are brought into removable engagement by inserting the second protrusion into the opening of the cavity defined by the first protrusion and magnetically coupling the first magnet of the first coupling mechanism and the second magnet of the second coupling mechanism to thereby magnetically and mechanically couple the first component and the second component so as to enable the first and second products to be transported together as the unit together.

The example embodiment of the coupling system of any preceding example embodiment or any combinations of preceding example embodiments, wherein the second protrusion comprises a shoulder radially extending outwardly from the second central axis about the circumferentially extending side wall and arranged in between the second top surface and the second protrusion surface.

The example embodiment of the coupling system of any preceding example embodiment or any combinations of preceding example embodiments, wherein a width of the opening extending through the portion of the first protrusion surface is narrower than a width of the opening extending through the portion of the side wall such that a lip is formed on the first protrusion surface that is narrower in width than a width of the shoulder of the second protrusion, such that when the second protrusion is inserted into the opening of the cavity defined by the first protrusion, the second protrusion is retained by contact between the shoulder and the lip.

The example embodiment of the coupling system of any preceding example embodiment or any combinations of preceding example embodiments, wherein the second protrusion surface has a width greater than a width of the circumferentially extending side wall of the second protrusion, the width of the second protrusion surface and a width of the shoulder being substantially the same or different.

The example embodiment of the coupling system of any preceding example embodiment or any combinations of preceding example embodiments, wherein the second protrusion surface contacts the first top surface of the first component and the first protrusion surface contacts the second top surface of the second component when the first component and the second component are brought into removable engagement.

The example embodiment of the coupling system of any preceding example embodiment or any combinations of preceding example embodiments, wherein the first product is a foldable chair and the second product is a foldable chair, each of the foldable chairs comprising a frame having a portion with a width that is smaller than a width of the first and second channels so that the portion of the frame of each foldable chair is receivable in one of the first and second channels.

The example embodiment of the coupling system of any preceding example embodiment or any combinations of preceding example embodiments, wherein the first bottom surface of the first component is formed by first and second bottom regions arranged opposed to one another on a respective one of the opposing sides of the body wall and separated by an area open to the first channel, and wherein the second bottom surface of the second component is formed by first and second bottom regions arranged opposed to one another on a respective one of the opposing sides of the body wall and separated by an area open to the second channel.

The example embodiment of the coupling system of any preceding example embodiment or any combinations of preceding example embodiments, wherein a first end of the two opposing ends of the first channel is defined by a first interior surface of the body wall that is arranged in a plane between the first top surface and the first bottom surface of the first component, a second interior surface of the body wall that is arranged opposed to the first interior surface and in a plane between the first bottom surface and the first interior surface of the first component, and an interior side wall arranged interior to the side of the body wall from which the first bottom portion of the first bottom surface is formed, and a second end of the two opposing ends of the first channel being defined by the first interior surface, the second interior surface, and an interior side wall arranged interior to the side of the body wall from which the second bottom portion of the first bottom surface is formed, and wherein a first end of the two opposing ends of the second channel is defined by a first interior surface of the body wall that is arranged in a plane between the second top surface and the second bottom surface of the second component, a second interior surface of the body wall that is arranged opposed to the first interior surface and in a plane between the second bottom surface and the first interior surface of the second component, and an interior side wall arranged interior to the side of the body wall from which the second bottom portion of the second bottom surface is formed, and a second end of the two opposing ends of the second channel being defined by the first interior surface, the second interior surface, and an interior side wall arranged interior to the side of the body wall from which the second bottom portion of the second bottom surface is formed.

The example embodiment of the coupling system of any preceding example embodiment or any combinations of preceding example embodiments, wherein a portion of the first product is received in the area open to the first channel on the first component, such that the first component is angled between about 0 degrees and about 90 degrees relative to the portion of the first product to allow for rotation of the first component between about 0 degrees and about 90 degrees relative to the portion of the first product so that the portion of the first product is received in the first channel, and wherein a portion of the second product is received in the area open to the second channel on the second component, such that the second component is angled between about 0 degrees and about 90 degrees relative to the portion of the second product to allow for rotation of the second component between about 0 degrees and about 90 degrees relative to the portion of the second product so that the portion of the second product is received in the second channel.

The example embodiment of the coupling system of any preceding example embodiment or any combinations of preceding example embodiments, wherein each of the first and second bottom portions of each of the first and second components comprises a retaining clip formed on the respective second interior surface and that extends toward the respective first interior surface to form a convex surface relative to the second interior surface so as to retain the respective portions of the first and second products within the respective first channel or second channel.

The example embodiment of the coupling system of any preceding example embodiment or any combinations of preceding example embodiments, wherein the first and second bottom regions of each of the first and second components are each formed as a right triangle with a 90 degree angle between an intersection of one of the two opposing ends and an adjacent one of the two opposing sides with a 45 degree angle relative to the respective side of the body wall from which the respective first and second bottom regions extend such that the first component is angled at about 45 degrees relative to the portion of the first product to allow for rotation of the first component about 45 degrees relative to the portion of the first product and the second component is angled at about 45 degrees relative to the portion of the second product to allow for rotation of the second component about 45 degrees relative to the portion of the second product.

The example embodiment of the coupling system of any preceding example embodiment or any combinations of preceding example embodiments, wherein the first interior surface and the second interior surface of each of the first and second component are planar and the interior side walls of each of the first and second components are curved to form a U-shaped cross-section of each of the first and second channels.

The example embodiment of the coupling system of any preceding example embodiment or any combinations of preceding example embodiments, wherein the first and second components are injection molded.

The example embodiment of the coupling system of any preceding example embodiment or any combinations of preceding example embodiments, wherein the first and second components are made of plastic.

The example embodiment of the coupling system of any preceding example embodiment or any combinations of preceding example embodiments, wherein the first and second coupling mechanisms are removably arranged on the first and second top surfaces of the respective first component and the second component.

The example embodiment of the coupling system of any preceding example embodiment or any combinations of preceding example embodiments, further comprising third and fourth components identical to a respective one of the first component and the second component, such that the first and third components are coupleable with the first product and the second and fourth components are coupleable with the second product, the first component and the second component and the third component and the fourth component being brought into removable engagement by coupling respective coupling mechanisms so as to enable the first and second products to be transported together as a unit.

The example embodiment of the coupling system of any preceding example embodiment or any combinations of preceding example embodiments, wherein the respective first and second top surfaces and the first and second body portions of each of the first component and the second component are fixedly engaged with one another as separate components or formed as an integral unit.

The example embodiment of the coupling system of any preceding example embodiment or any combinations of preceding example embodiments, wherein the two opposing sides of the first and second components are longer in length than a length of the respective two opposing ends of the first and second components.

### BRIEF DESCRIPTION OF THE FIGURE(S)

In order to assist the understanding of aspects of the disclosure, reference will now be made to the appended drawings, which are not necessarily drawn to scale. The drawings are provided by way of example to assist in the understanding of aspects of the disclosure, and should not be construed as limiting the disclosure.

FIG. 1 illustrates a coupling system transporting two foldable chairs together as a unit according to some example embodiments of the present disclosure;

FIGS. 2A-2E illustrate various views of a first component of a coupling system according to some example embodiments of the present disclosure;

FIGS. 3A-3C illustrate various views of a second component of a coupling system according to some example embodiments of the present disclosure;

FIGS. 4A-4F illustrate various views of a coupling system with a first component and a second component brought into removable engagement according to some example embodiments of the present disclosure;

FIGS. 5A-5B illustrate the process of coupling a coupling system to foldable chairs according to some example embodiments of the present disclosure; and

FIGS. 6A-6B illustrate the process of bringing a first component and a second component of a coupling system into removable engagement according to some example embodiments of the present disclosure.

### DETAILED DESCRIPTION

Some embodiments of the present disclosure will now be described more fully hereinafter with reference to the accompanying figures, in which some, but not all embodiments of the disclosure are shown. Indeed, various embodiments of the disclosure may be embodied in many different forms and should not be construed as limited to the embodiments set forth herein; rather, these example embodiments are provided so that this disclosure will be thorough and complete, and will fully convey the scope of the disclosure to those skilled in the art.

For example, unless specified otherwise or clear from context, references to first, second or the like should not be construed to imply a particular order. A feature described as being above another feature (unless specified otherwise or clear from context) may instead be below, and vice versa; and similarly, features described as being to the left of another feature may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise, or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Like reference numerals refer to like elements throughout.

As used herein, the terms “bottom,” “top,” “upper,” “lower,” “upward,” “downward,” “rightward,” “leftward,” “interior,” “exterior,” and/or similar terms are used for ease of explanation and refer generally to the position of certain components or portions of the components of embodiments of the described disclosure. It is understood that such terms are not used in any absolute sense.

As used herein, “directly” engaged, coupled, joined, etc., means that two or more components are connected via direct contact with one another, i.e., touching, whereas “indirectly” engaged, coupled, joined, etc., means that two or more components do not directly contact one another, but are still connected via one or more intervening component. Such direct or indirect engagement, coupling, joining, etc., may be permanent or may be removable, unless otherwise specified. Likewise, the use of engage, couple, join, connect, fasten, etc., is not to be limited to being indirect or direct, and/or permanent or removable, unless otherwise specified.

As used herein, “fastener(s)” may refer to any type of hardware device or mechanism that mechanically, magnetically, chemically, etc., affixes or joins two or more objects together. Though generally a fastener may be used to create a non-permanent joint, as used herein, “fastener” may refer to both permanent and non-permanent joints unless otherwise specified. Exemplary fasteners may include, but are not limited to, a threaded fastener (e.g., screws, nuts, and bolts, captive threaded fasteners, studs, threaded inserts, and threaded rods), anchor bolt, batten, bolt snap, brass fastener, buckle, button, cable tie, cam, captive fastener, clamp (or cramp), hose clamp, clasp and shackle, bolt snap, carabiner, circle cotter, lobster clasp, cleco, clip, binder clip, BULLDOG® clip, crocodile clip, circlip, clothespin, hairpin clip, paper clip, terry clip, clutch, drawing pin (thumbtack), flange, frog, grommet, hook-and-eye closure, hook and loop fastener, VELCRO®, latch, nail and rivet, solid/round head rivets, semi-tubular rivets, blind (pop) rivet, pegs, tent peg, PEM nut, pins, clevis fastener, cotter, dowel, linchpin, R-clip, safety pin, split pin, spring pin, tapered pin, retaining rings, e-ring, well nut, rock bolt, rubber band (or bands of other materials), screw anchor, snap fastener, snap-fit engagement, staple, stitches, strap, tie, toggle bolt, tolerance ring, treasury tag, twist tie, wedge anchor, and zipper. Otherwise, components affixed together may be joined using a permanent joint such as, but not limited to, crimping, welding, soldering, brazing, taping, gluing, cement, or the use of other adhesives. Force may also be used, such as with magnets, vacuum (like suction cups), or even friction (like sticky pads). Some types of woodworking joints make use of separate internal reinforcements, such as dowels or biscuits, which in a sense may be considered fasteners as used herein.

The present disclosure is directed to a coupling system, designated as 10. The coupling system may be utilized to removably engage first and second products 12, 14 for transport together as a unit. As used herein, “unit” means a single or complete entity, such that the first and second products 12, 14 are more easily transportable as a “unit” or single entity than they would be as two individual products. Such products may be any type of consumer product that requires transport to a location and may be readily carried (as determined by weight, shape, materials, etc.)

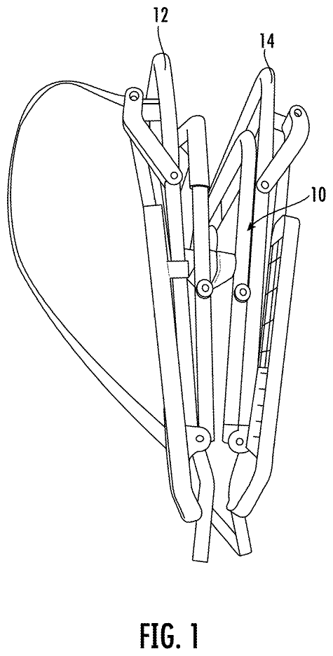

In some example embodiments, the first and second products 12, 14 are foldable chairs. The products being “foldable” means that the chairs are designed to be maneuvered between two configurations—a supporting configuration in which the foldable chair bears weight from a user and a transport configuration in which the foldable chair is collapsed into a compact arrangement for easier transport, though the chair may also be transportable in the supporting configuration. As used herein, collapsing means that the components of the foldable chair are brought closer together in one or more of the X, Y, and Z directions. For example, the coupling system 10 is illustrated with the first and second products 12, 14 being foldable chairs in FIG. 1, where only a single carrying mechanism (such as one or more straps) of the first foldable chair is carried by the user, and the second foldable chair is removably engaged with the first foldable chair via the coupling system 10, and is not directly in contact with the user. As seen in this example embodiment, the user is capable of transporting both chairs on his back as a unit without having to wear the carrying mechanisms of both the first foldable chair and the second foldable chair.

Such an arrangement as shown in FIG. 1 is desirable as previously, carrying more than one foldable chair required use of at least one hand to carry one of the foldable chairs should the other foldable chair be carried on the back. Otherwise, should the foldable chairs not include a wearable strap, one chair would need to be carried in each hand. This leaves it difficult to transport other miscellaneous items, such as, for example, bags, coolers, shading systems, umbrellas, tents, and the like. Even more desirable, the design of the coupling system 10 as described further below is such that a user may be able to carry up to six chairs at once using three coupling systems 10: two foldable chairs removably engaged to one another via a first coupling system 10 and worn on the back of the user by a set of back straps or other carrying mechanism coupled to one of the chairs (as shown in FIG. 1), two foldable chairs removably engaged to one another via a second coupling system 10 and carried by a component (such as part of the frame or other carrying mechanism of one of the chairs) in a right hand of the user, and two foldable chairs removably engaged to one another via a third coupling system 10 and carried by a component (such as part of the frame or other carrying mechanism of one of the chairs) in a left hand of the user. Based on the design of the foldable chairs, even more foldable chairs may be otherwise stacked or carried by the user using additional coupling systems 10—such as two foldable chairs removably engaged to one another via a fourth coupling system 10 and worn on a shoulder 54 of the user by a set of back straps or other carrying mechanism coupled to one of the chairs. Thus, the coupling system 10 may significantly reduce the difficulties in transporting a large number of products (such as foldable chairs) to a location, such as the beach, camp site, tailgating, etc. Moreover, the coupling system 10 may also beneficially reduce difficulties that may arise in storing large quantities of chairs (such as for a rental company or while in retail) by storing chairs together as a unit, which may allow for easily stacking or storing chairs together in a single orientation.

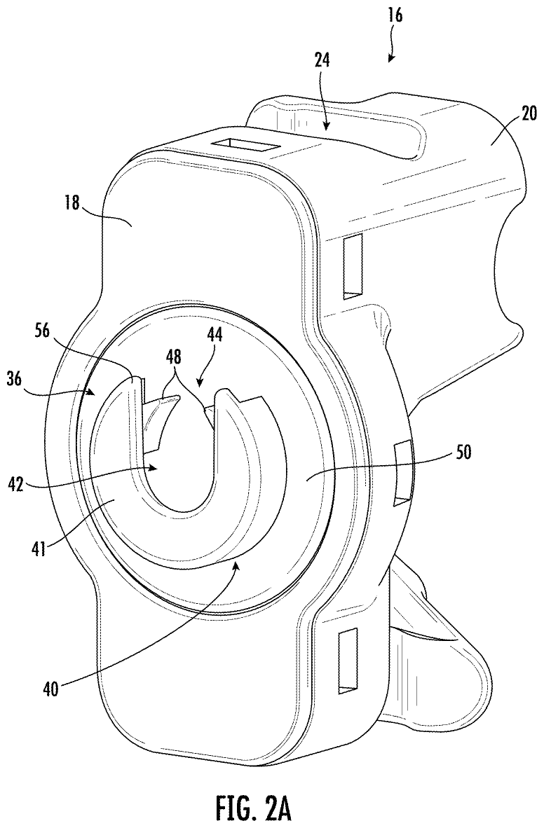

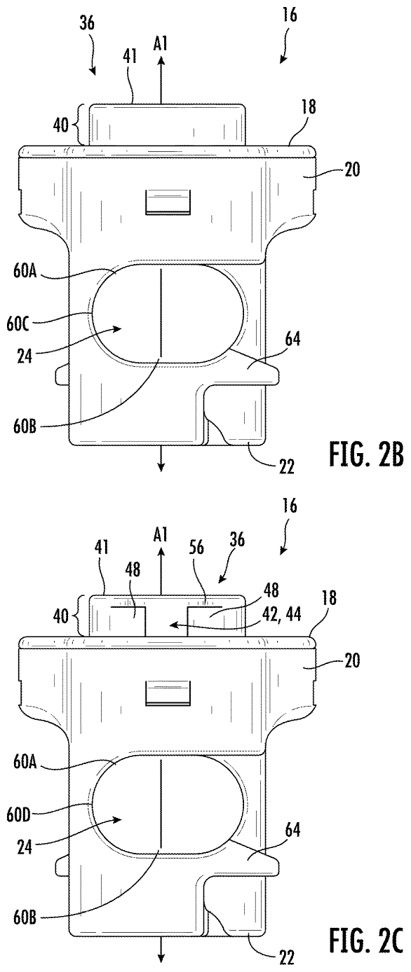

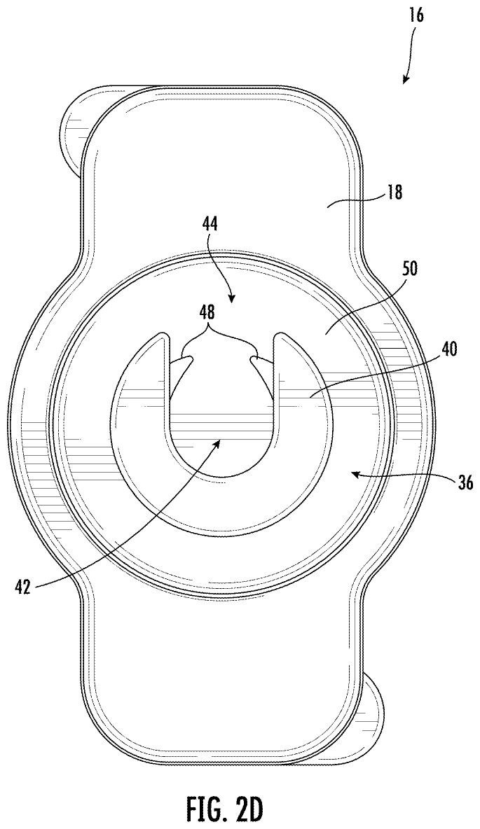

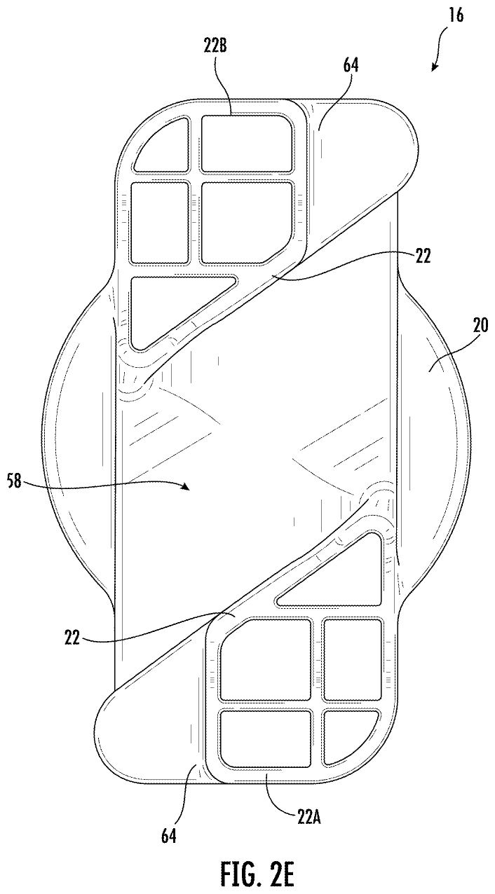

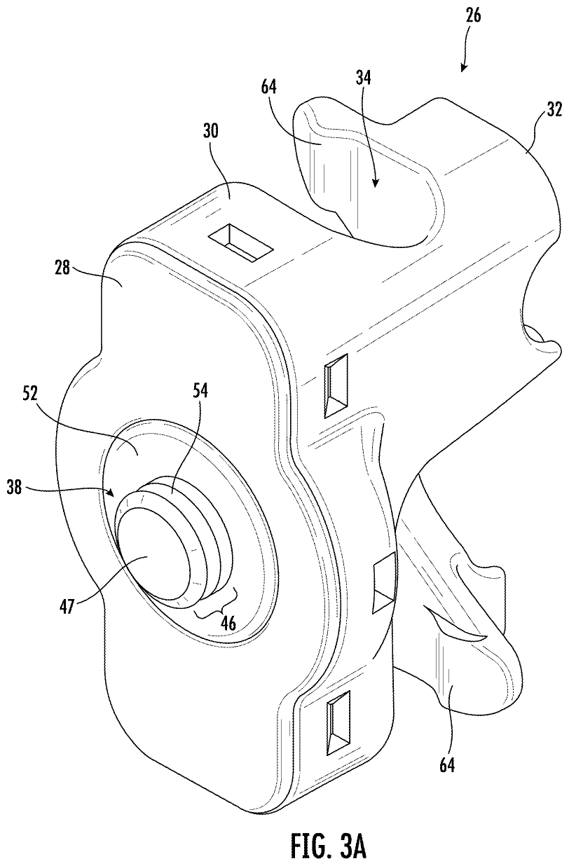

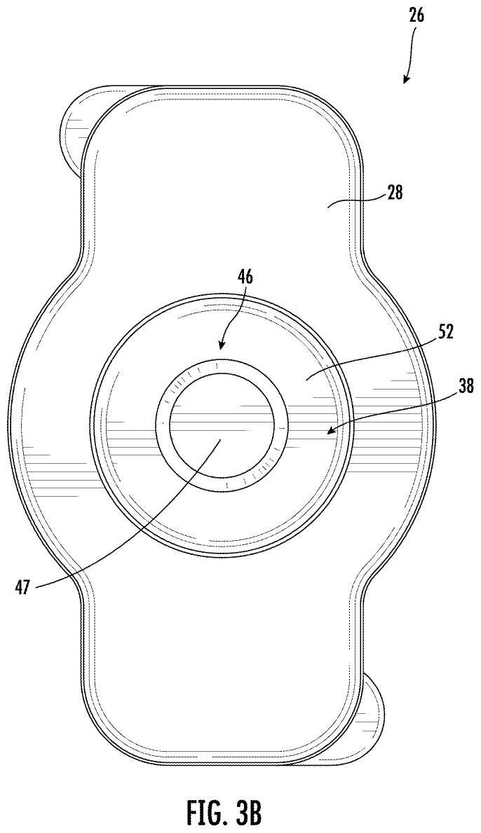

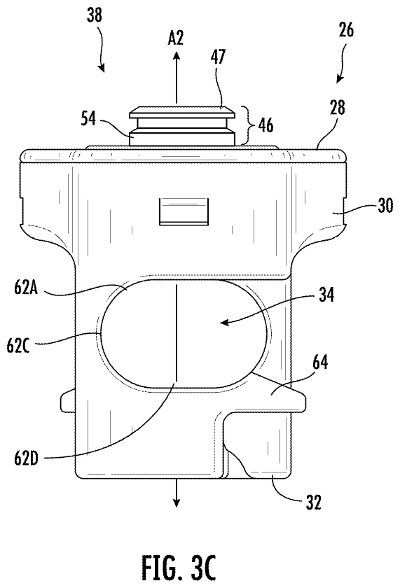

The coupling system 10 may thus be described hereinbelow. In one example embodiment, the coupling system 10 comprises a first component 16 comprising a first top surface 18 and a first body portion 20 defined by a body wall having two opposing sides and two opposing ends and extending from the first top surface 18 to a first bottom surface 22 opposing the first top surface 18. A first channel 24 may be formed through the two opposing ends of the body wall of the first body portion 20 and between the first top surface 18 and the first bottom surface 22. The first component 16 is illustrated in some example embodiments in FIGS. 2A-2E. Additionally, the coupling system 10 may comprise a second component 26 comprising a second top surface 28 and a second body portion 30 defined by a body wall having two opposing sides and two opposing ends and extending from the second top surface 28 to a second bottom surface 32 opposing the second top surface 28. A second channel 34 may be formed through the two opposing ends of the body wall of the second body portion 30 and between the second top surface 28 and the second bottom surface 32. The second component 26 is illustrated in some example embodiments in FIGS. 3A-3C.

In some example embodiments, and as shown in FIGS. 2A and 3A, the two opposing sides of the first and second components 16, 26 are longer in length than a length of the respective two opposing ends of the first and second components 16, 26. However, in some other example embodiments, the opposite is true and the two opposing sides of the first and second components 16, 26 are shorter in length than a length of the respective two opposing ends of the first and second components 16, 26. In some still further example embodiments, the two opposing sides of the first and second components 16, 26 are substantially a same in length than a length of the respective two opposing ends of the first and second components 16, 26. Any shape, size, dimensions, material, etc., is envisioned within this disclosure that will allow the coupling system 10 to transport products having any number of shapes, dimensions, weight, etc.

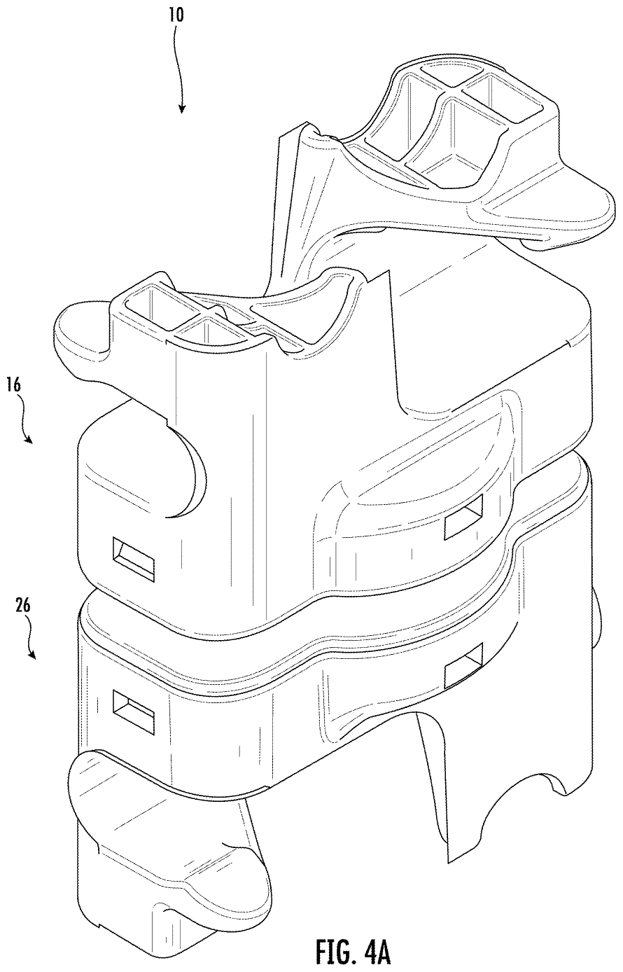

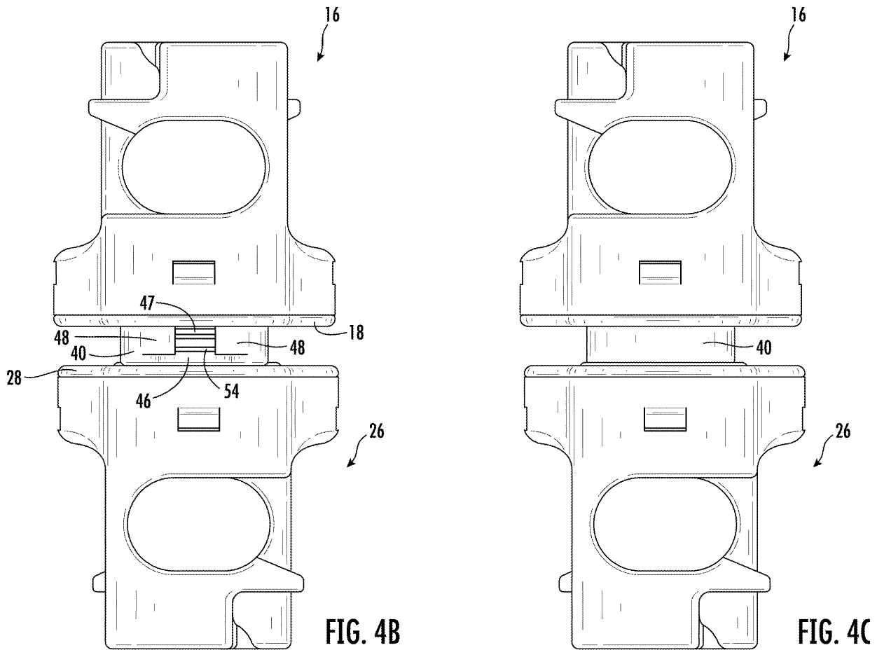

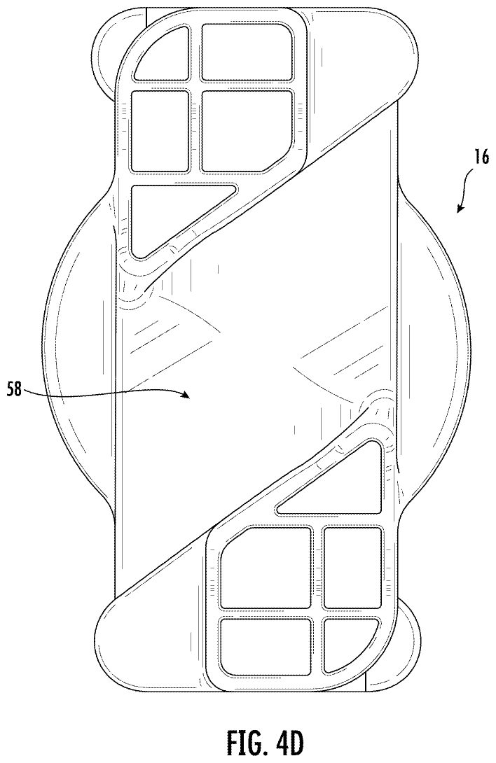

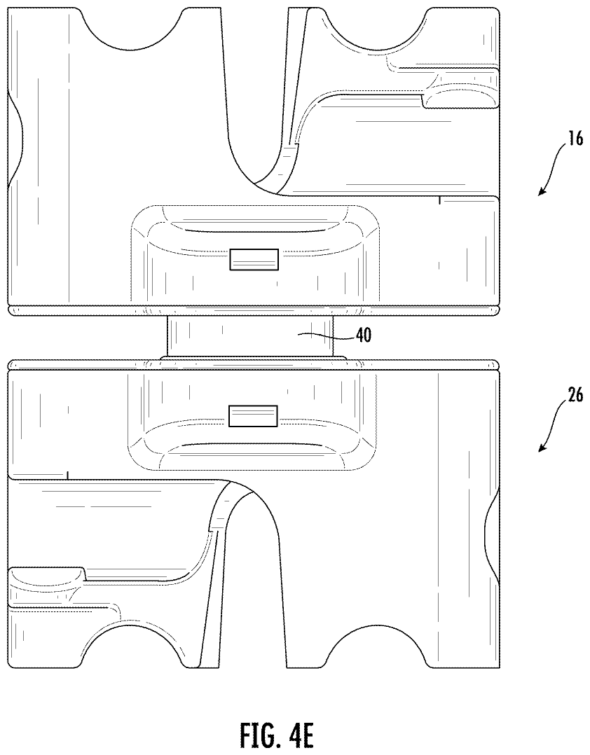

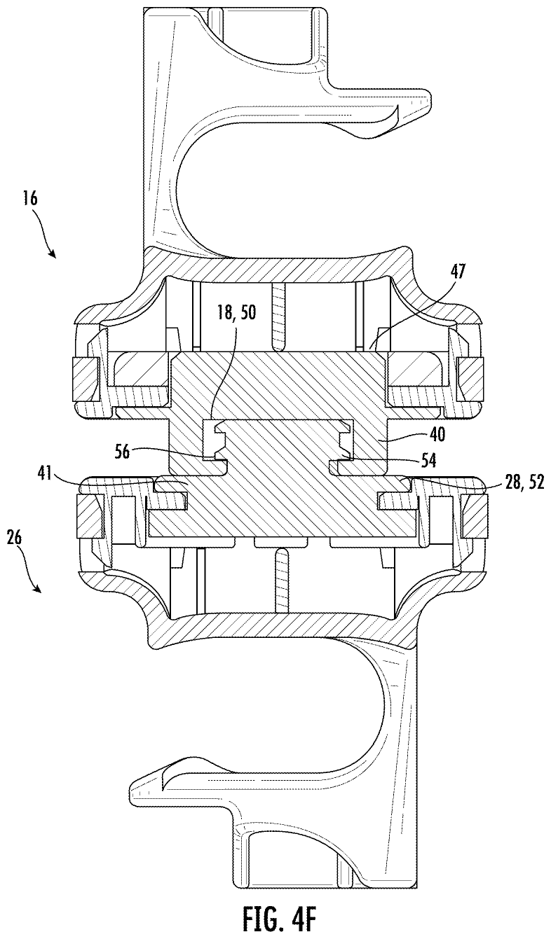

To removably engage the first component 16 and the second component 26 of the coupling system 10, the first component 16 may comprise a first coupling mechanism 36 and the second component 26 may comprise a second coupling mechanism 38 complementary to the first coupling mechanism 36. As used herein, “complementary” means that each of the first coupling mechanism 36 and the second coupling mechanism 38 are two mutually completing parts or counterparts to one another. Thus, when the first component 16 is coupleable with a first product 12 (e.g., a first foldable chair) receivable in the first channel 24 and the second component 26 is coupleable with a second product 14 (e.g., a second foldable chair) receivable in the second channel 34, the first component 16 and the second component 26 are brought into removable engagement by coupling the first and second coupling mechanisms 36, 38 together so as to enable the first and second products 12, 14 to be transported together as a unit. Moreover, the first component 16 and the second component 26 may be removably disengaged by uncoupling the first and second coupling mechanisms 36, 38 from one another. So as to enable the first and second products 12, 14 to each be utilized in the supporting configuration as separate units. Thus, the coupling of the first and second coupling mechanisms 36, 38 results in removable engagement of the first component 16 and the second component 26. The first component 16 and the second component 26 being brought into removable engagement without the first and second products 12, 14 is shown in some example embodiments in FIGS. 4A-4F.

In some example embodiments, the first coupling mechanism 36 comprises a first magnet (not shown) arranged within the first body portion 20 and adjacent to the first top surface 18, and the second coupling mechanism 38 comprises a second magnet (not shown) arranged within the second body portion 30 and adjacent to the second top surface 28. The first magnet and the second magnet may be shaped so that they are able to be arranged within their respective body portions. For example, the first magnet and the second magnet may be axially magnetized disc magnets having the north and south poles on opposing flat surfaces. In this example, the first magnet may be coaxially aligned in the first body portion 20 of the first component 16 with a first central axis A1 and with a first polarity facing the first top surface 18, while the magnet of the second polarity may be coaxially aligned in the second body portion 30 of the second component 26 with a second central axis A2 and with a second polarity opposite to the first polarity facing second top surface 28. In such an instance, the magnets may be so arranged so that the first polarity of the first magnet facing the first top surface 18 is one of north or south, while the second polarity of the second magnet facing the second top surface 28 is the other of south or north. Other types of magnets may also be used and are contemplated herein, where such magnets may be arranged within their respective body portion so that when engaged opposing polarities may attract one another to effect a magnetic coupling.

In this way, the first and second coupling mechanisms 36, 38 including the first and second magnets enable the first coupling mechanism 36 and the second coupling mechanism 38 being brought into removable engagement by magnetically coupling the first magnet of the first coupling mechanism 36 and the second magnet of the second coupling mechanism 38 so as to enable the first and second products 12, 14 to be transported together as the unit. However, in order to transport the first and second products 12, 14 together as a unit, a strength of each magnet must be great enough so as to withstand a counterweight of the first and second products 12, 14 combined, but also be easily disengagable for a variety of differently-abled users. Such a magnetic strength will be able to hold first and second products 12, 14 having a combined weight of between about 5 and about 30 pounds.

In some example embodiments, the first coupling mechanism 36 may further comprise in addition to or instead of the first magnet, a first protrusion 40 defining the first central axis A1 and extending from the first top surface 18 to a first protrusion surface 41 with a circumferentially extending side wall arranged between the first top surface 18 and the first protrusion surface 41. The first protrusion 40 may define a cavity 42 having an opening 44 extending radially outwardly from the first central axis A1 and through a portion of the side wall and a portion of the first protrusion surface 41. The second coupling mechanism 38 may further comprise in addition to or instead of the second magnet, a second protrusion 46 defining the second central axis A2 and extending from the second top surface 28 to a second protrusion surface 47 with a circumferentially extending side wall arranged between the second top surface 28 and the second protrusion surface 47. The second protrusion 46 may be inserted into the cavity 42 of the first protrusion 40 for removable engagement.

Notably, in some example embodiments, the first protrusion 40 may include a resilient locking mechanism comprising latching projections 48, which engage the second protrusion 46 in a form fit manner for establishing the mechanical latching by resiliently retracting when the second protrusion 46 is inserted past the latching projections 48 and into the cavity 42 and then returning to neutral when the second protrusion 46 is fully received within the cavity 42. Other locking mechanisms for effecting the mechanical coupling between the first protrusion 40 and the second protrusion 46 are also contemplated herein, such as, for example, a sliding “keyhole” connection, snap or strap connection, spring push snap button, spring button clip, hook and loop, one or more fastener(s), dual hook or two “c” shaped clips that attach on opposite directions, or shelf connection may be possible instead of or in addition to the first and second magnets.

In this way, the first and second coupling mechanisms 36, 38 including the first and second protrusions 40, 46 enable the first coupling mechanism 36 and the second coupling mechanism 38 being brought into removable engagement by mechanically coupling the first protrusion 40 of the first coupling mechanism 36 and the second protrusion 46 of the second coupling mechanism 38 so as to enable the first and second products 12, 14 to be transported together as the unit.

However, where the first coupling mechanism 36 comprises the first magnet and the first protrusion 40, and the second coupling mechanism 38 comprises the second magnet and the second protrusion 46, the first component 16 and the second component 26 may be brought into removable engagement by inserting the second protrusion 46 into the opening 44 of the cavity 42 defined by the first protrusion 40 and magnetically coupling the first magnet of the first coupling mechanism 36 and the second magnet of the second coupling mechanism 38 to thereby magnetically and mechanically couple the first component 16 and the second component 26 so as to enable the first and second products 12, 14 to be transported together as the unit together. In other words, when the first coupling mechanism 36 and the second coupling mechanism 38 are brought into proximity with one another (i.e., contact with), the first magnet and the second magnet magnetically attract one another to help align and guide the second protrusion 46 past the latching projections 48 (which resiliently retract) of the first protrusion 40 and into the opening 44 of the cavity 42. Once the second protrusion 46 is fully received in the cavity 42, the latching projections 48 spring back or return to neutral. Having both the magnetic and mechanical coupling in the first and second coupling mechanisms 36, 38 is beneficial in that the magnetic attraction between the first magnet and the second magnet assists in urging the mechanical coupling of the first protrusion 40 with the second protrusion 46 so as to make for a smoother user experience in engaging the first and second coupling mechanisms 36, 38.

In some example embodiments, one or both of the first and second coupling mechanisms 36, 38 may be removably engaged with one or both of the respective top surface and the body portion using a subassembly, such as that described in U.S. Pat. No. 8,794,682 assigned to Fidlock GmbH. For example, the first top surface 18 may comprise an opening sized to receive a first planar surface 50 from which the first protrusion 40 extends of the first coupling mechanism 36. The first planar surface 50 of the first coupling mechanism 36 may be substantially co-planar with the first top surface 18 of the first component 16 when the first coupling mechanism 36 is inserted into the opening. The first magnet may be similarly arranged on an underside of the first planar surface 50 and held in place by a fastener of some type such as a lock ring, a clip, a screw, an adhesive, etc. The first planar surface 50 of the first carrying mechanism may be either removably or fixedly secured within the first body portion 20 and/or the first top surface 18 so that it cannot be removed by the user. Otherwise, the first carrying mechanism may be easily removed by the user for purposes such as, for example, cleaning the first component 16. In other embodiments, the first carrying mechanism is integrally made so that the first protrusion 40 extends from the first top surface 18 of the first component 16. Similarly, for example, the second top surface 28 may comprise an opening sized to receive a second planar surface 52 from which the second protrusion 46 extends of the second coupling mechanism 38. The second planar surface 52 of the second coupling mechanism 38 may be substantially co-planar with the second top surface 28 of the second component 26 when the second coupling mechanism 38 is inserted into the opening. The second magnet may be similarly arranged on an underside of the second planar surface 52 and held in place by a fastener of some type such as a lock ring, a clip, a screw, an adhesive, etc. The second planar surface 52 of the second carrying mechanism may be either removably or fixedly secured within the second body portion 30 and/or the second top surface 28 so that it cannot be removed by the user. Otherwise, the second carrying mechanism may be easily removed by the user for purposes such as, for example, cleaning the second component 26. In other embodiments, the second carrying mechanism is integrally made so that the second protrusion 46 extends from the second top surface 28 of the second component 26. In this way, manufacture of the various components of the coupling system may be made easier as the coupling mechanisms may be separately made and assembled from the top surfaces and/or body portions.

FIG. 4F is a cross-sectional view of the removable engagement of the first and second components 16, 26 of the coupling system 10. As shown in FIG. 4F, the second protrusion 46 comprises a shoulder 54 radially extending outwardly from the second central axis A2 about the circumferentially extending side wall and arranged in between the second top surface 28 and the second protrusion surface 47. In this embodiment, a width of the opening 44 extending through the portion of the first protrusion surface 41 is narrower than a width of the opening 44 extending through the portion of the side wall such that a lip 56 is formed on the first protrusion surface 41 that is narrower in width than a width of the shoulder 54 of the second protrusion 46. As such, when the second protrusion 46 is inserted into the opening 44 of the cavity 42 defined by the first protrusion 40, the second protrusion 46 is retained by contact between the shoulder 54 and the lip 56. In some further example embodiments, the second protrusion surface 47 may have a width greater than a width of the circumferentially extending side wall of the second protrusion 46, where the width of the second protrusion surface 47 and a width of the shoulder 54 being substantially the same or different. In this way, a circumferential groove is formed about a circumference of the second protrusion 46 between the second protrusion surface 47 and the shoulder 54, where such a circumferential groove may receive the latching projections 48 of the first protrusion 40. Such an interaction between the first and second protrusions 40, 46 effects a secure mechanical connection therebetween in transport, that is also easily removable as needed.

In some example embodiments, to disengage the first and second protrusions 40, 46, a user may lift the product coupled with the second component 26 so that it slides out of the opening 44 of the cavity 42 in the first protrusion 40. As discussed in more detail below, in some example embodiments, the coupling mechanisms 36, 38 are configured such that there is only one direction in which you can disengage the first and second protrusions 40, 46. For example, where the opening 44 of the cavity 42 is facing upwards, the user may lift the product coupled with the second component 26 in an upward direction, which upward movement simultaneously magnetically and mechanically uncouples the coupling mechanisms 36, 38 by causing the latching projections 48 to retract while the second protrusion 46 exits the cavity 42 and bias back to neutral upon full removal of the second protrusion 46 from the cavity 42. A similar disengagement process is used in another example, where the opening 44 of the cavity 42 is facing downwards. There, the user may pull the product coupled with the second component 26 in a downward direction, which downward movement simultaneously magnetically and mechanically uncouples the coupling mechanisms 36, 38 by causing the latching projections 48 to retract and then bias back to neutral upon full removal of the second protrusion 46 from the cavity 42. Advantageously, configuring the first and second components such that the first and second protrusions 40, 46 may only be disengaged from movement in a single direction may prevent accidental disengagement during transport.

Accordingly, the second protrusion surface 47 contacts the first top surface 18/first planar surface 50 of the first component 16 and the first protrusion surface 41 contacts the second top surface 28/second planar surface 52 of the second component 26 when the first component 16 and the second component 26 are brought into removable engagement. As used herein, “contact” can refer to “direct” contact or close to “direct” contact where there is a small gap of space between the second protrusion surface 47 and the first top surface 18/first planar surface 50 and/or the first protrusion surface 41 and the second top surface 28/second planar surface 52.

Turning now to the first body portion 20 of the first component 16, and the second body portion 30 of the second component 26, the body portions may have slightly different configurations depending on how the products are respectively coupleable with the first and second components 16, 26. For example, in one embodiment and as shown in a bottom view of the first component 16 in FIG. 2E, the first bottom surface 22 of the first component 16 may be formed by first and second bottom regions 22A, 22B arranged opposed to one another on a respective one of the opposing sides of the body wall and separated by an area open 58 to the first channel 24. Similarly, the second bottom surface 32 of the second component 26 may be formed by first and second bottom regions (not shown, but identical in this embodiment to the first and second bottom regions 22A, 22B of the first component 16) arranged opposed to one another on a respective one of the opposing sides of the body wall and separated by an area open 58 to the second channel 34. Notably, although the bottom view of the second component 26 is identical to that of the first component 16 shown in FIG. 2E, in other example embodiments, the first and second bottom surfaces 22, 32 may differ, such as by being mirror images of one another.

In this example embodiment, and as shown in the left side view of the first component 16 in FIG. 2B, a first end of the two opposing ends of the first channel 24 may be defined by a first interior surface of the body wall 60A that is arranged in a plane between the first top surface 18 and the first bottom surface 22 of the first component 16, a second interior surface of the body wall 60B that is arranged opposed to the first interior surface and in a plane between the first bottom surface 22 and the first interior surface of the first component 16, and an interior side wall 60C arranged interior to the side of the body wall from which the first bottom portion of the first bottom surface 22 is formed. FIG. 2C illustrates a right side view of the second component 26, with a second end of the two opposing ends of the first channel 24 being defined by the first interior surface, the second interior surface, and an interior side wall 60D arranged interior to the side of the body wall from which the second bottom portion of the first bottom surface 22 is formed. The cavity 42 is visible in the first protrusion 40 of the first component 16 in FIG. 2C.

In this example embodiment, and as shown in a left side view of the second component 26 in FIG. 3C, a first end of the two opposing ends of the second channel 34 may be defined by a first interior surface of the body wall 62A that is arranged in a plane between the second top surface 28 and the second bottom surface 32 of the second component 26, a second interior surface of the body wall 62B that is arranged opposed to the first interior surface and in a plane between the second bottom surface 32 and the first interior surface of the second component 26, and an interior side wall 62C arranged interior to the side of the body wall from which the second bottom portion of the second bottom surface 32 is formed. A second end (not shown, but identical to the first end in this embodiment) of the two opposing ends of the second channel 34 may be defined by the first interior surface, the second interior surface, and an interior side wall arranged interior to the side of the body wall from which the second bottom portion of the second bottom surface 32 is formed.

In some example embodiments, and as shown in FIGS. 2B-2C and 3C, each of the first and second bottom portions of each of the first and second components 16, 26 may comprise a retaining clip 64 formed on the respective second interior surface and that extends toward the respective first interior surface to form a convex surface relative to the second interior surface so as to retain the respective portions of the first and second products 12, 14 within the respective first channel 24 or second channel 34. As shown, in this example embodiment, the retaining clip 64 is so formed to allow it to elastically deform from a neutral position so that when the portion of the first and second products 12, 14 is being inserted into the first or second channel 24, 34, the retaining clip 64 deforms from its neutral position to allow the portion of the first and second product to enter the first or second channel 24, 34. Once the portion is within the first or second channel 24, 34, the retaining clip 64 returns back to its neutral position. A tapered angle at a distal end of each retaining clip 64 presses against the portion of the product to retain it in the channel 24, 34 when the retaining clip 64 is in the neutral position. This retaining clip 64 may take on a variety of other form factors, such as, for example, a rubber component that uses friction to prevent slippage, clip(s), fastener(s), lock(s), magnet(s),

The first and second channels 24, 34 may take on a variety of cross-sectional shapes depending on a corresponding shape of the product desired to be received therein. In some example embodiments, the first interior surface 60A, 62A and the second interior surface 60B, 62B of each of the first and second component 26 may be planar and the interior side walls 60C, 62C of each of the first and second components 16, 26 may be curved to form a U-shaped cross-section of each of the first and second channels 24, 34. This may allow for products having a portion with a cross-sectional shape that is substantially a flattened-oval shape (i.e., two vertical sides that are connected by arcs) to be received in the respective channel. Otherwise, the various surfaces and side walls forming each of the first and second channels 24, 34 may be so formed so as to provide a square, rectangular, circular, oval, triangular, trapezoidal, etc., cross-section.

In addition to receiving a product with a complementary shape, the first and second channels 24, 34 may be sized so as to receive a product with a complementary size. For example, the first and second channels 24, 34 may have dimensions of a height of between about 15 millimeters (mm) to about 30 mm and a width of between about 15 mm to about 35 mm so as to receive products with exterior widths of the portion to be received in the channels as being between about 10 mm to about 30 mm, though this may vary depending on the cross-sectional shape of the received portion. For example, where the first product 12 is a foldable chair and the second product 14 is a foldable chair, each of the foldable chairs may comprise a frame having a portion with a width that is smaller than a width of the first and second channels 24, 34 so that the portion of the frame of each foldable chair is receivable in one of the first and second channels 24, 34.

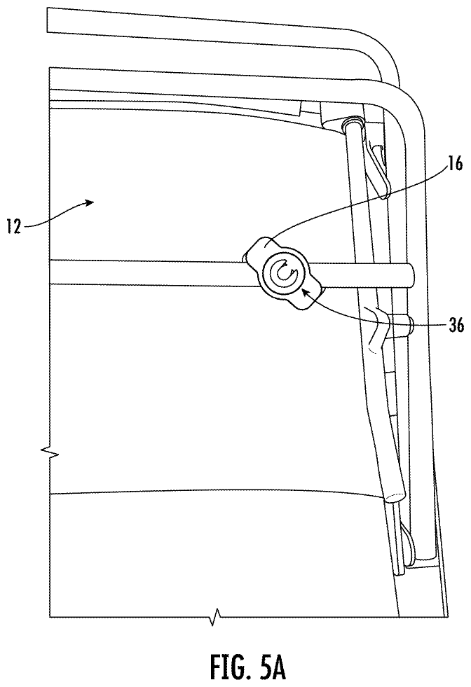

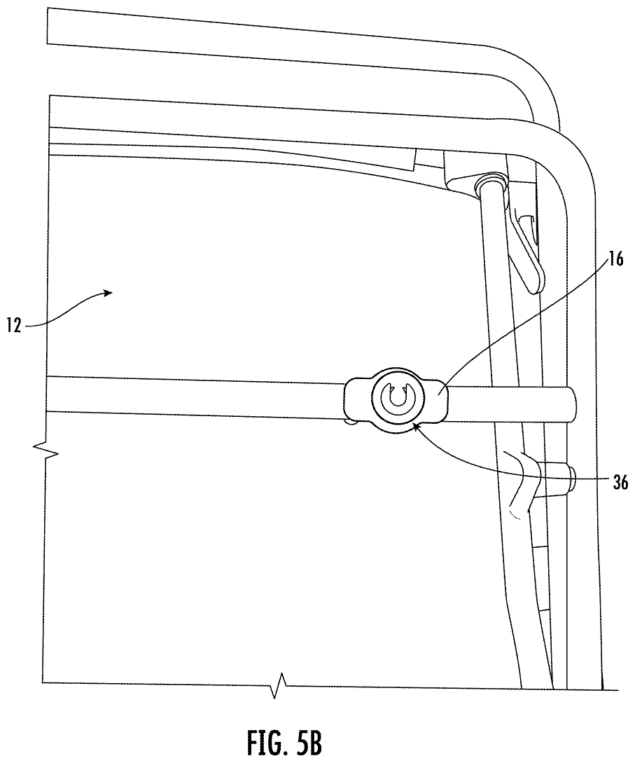

Accordingly, the process of coupling the first component 16 of the coupling system 10 to the product is shown in FIGS. 5A-5B. In this embodiment, the process of coupling the second component 26 of the coupling system 10 is identical though it is not shown. Generally, a portion of the first product 12 may be received in the area open 58 to the first channel 24 on the first component 16, such that the first component 16 is angled between about 0 degrees and about 90 degrees relative to the portion of the first product 12 to allow for rotation of the first component 16 in a first direction between about 0 degrees and about 90 degrees relative to the portion of the first product 12 so that the portion of the first product 12 is received in the first channel 24. Preferably, the first protrusion 40 of the first component 16 is coupled to the portion of the product so that the opening 44 of the cavity 42 is facing upwards, such that the first component 16 is rotated in a counterclockwise direction. Doing so beneficially prevents the latching projections 48 from also having to counteract gravity while retaining second projection. Likewise, a portion of the second product 14 may be received in the area open 58 to the second channel 34 on the second component 26, such that the second component 26 is angled between about 0 degrees and about 90 degrees relative to the portion of the second product 14 to allow for rotation of the second component 26 in a first direction (either clockwise or counterclockwise) between about 0 degrees and about 90 degrees relative to the portion of the second product 14 so that the portion of the second product 14 is received in the second channel 34. To uncouple each of the first and second components 16, 26 from the respective portion of the first or second product 14, the user may simply rotate the first or second component 26 between about 0 degrees and about 90 degrees relative to the portion of the first or second product 14 in a second direction, the second direction being opposite the first direction for each of the first and second component 26.

The angle required to couple the first and second components 16, 26 with the respective products, and the resulting degree of rotation required to fully seat the first and second products 12, 14 within a respective channel, may depend on the shape and size of the first and second bottom regions 22A, 22B. For example, as shown in FIGS. 2A-2E, 3A-3C, and 4A-4F, the first and second bottom regions 22A, 22B of each of the first and second components 16, 26 are each formed as a right triangle with about a 90 degree angle between an intersection of one of the two opposing ends and an adjacent one of the two opposing sides with a 45 degree angle relative to the respective side of the body wall from which the respective first and second bottom regions 22A, 22B extend. As such, and as shown in FIG. 5A, when the portion of the first component 16 is received in the area open 58 to the first channel 24 on the first component 16, the first component 16 may be angled at about 45 degrees relative to the portion of the first product 12 to allow for rotation of the first component 16 about 45 degrees counterclockwise relative to the portion of the first product 12 so that the cavity 42 is facing upward (FIG. 5B). Similarly, though not shown, when the portion of the second component 26 is received in the area open 58 to the second channel 34 on the second component 26, the second component 26 may be angled at about 45 degrees relative to the portion of the second product 14 to allow for rotation of the second component 26 about 45 degrees either clockwise or counterclockwise relative to the portion of the second product 14.

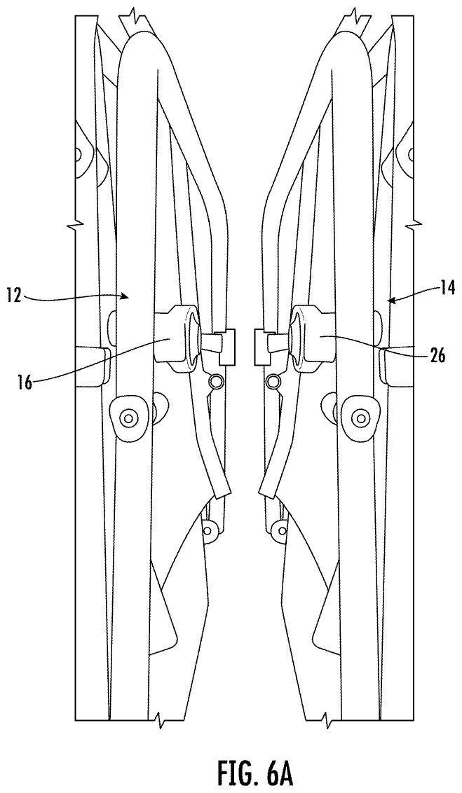

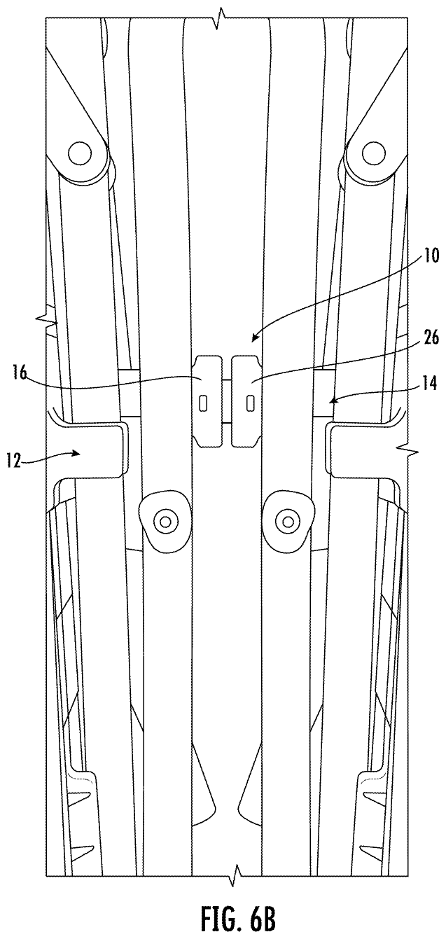

In some example embodiments, the coupling system 10 further comprises third and fourth components identical to a respective one of the first component 16 and the second component 26. The third and fourth components may be coupled to a respective product similarly to how the first and second components 16, 26 are coupled thereto. For example, the first and third components may be coupleable with the first product 12 and the second and fourth components may be coupleable with the second product 14. Where there is more than one component used on a product, it may be desirable to space out each component along the portion of the product. In this way, the first component 16 and the second component 26 and the third component and the fourth component may be brought into removable engagement by coupling respective coupling mechanisms so as to enable the first and second products 12, 14 to be transported together as a unit. A coupling system having four components is thus shown in FIGS. 6A-6B. As shown in FIG. 6A, the first and third components are spread apart along the portion of the first product 12, while the second and fourth components are spread apart along the portion of the second product 14. As shown in FIG. 6B, the components are removably engaged as described herein, though removable engagement of only the first and second product 14 is visible in this figure.

The coupling system 10 may be manufactured in many different ways, some of which may depend on the material of the components of the coupling system 10. For example, the components may each be formed of Acrylonitrile Butadiene Styrene (ABS) plastic and be injection molded. Alternatively, the components may be machined or forged from metal, such as aluminum. The present disclosure contemplates any other type of manufacturing process including CNC machining, 3D printing, and the like. Alternatively, one or more aspects of the components may be formed out of any molded plastic, may include metal fasteners or metal parts such as, for example, aluminum. Thus, the coupling system 10 may be formed as an integral monolithic unit of one material, or may be composed of one or more material.

Additionally, each of the components of the coupling system 10 may be formed as separate components or a single component. In other words, the respective first and second top surfaces 18, 28, the first and second body portions 20, 30, and/or the first and second coupling mechanisms 36, 38 of each of the first component 16 and the second component 26 may be fixedly engaged with one another as separate components or formed as an integral unit. The fixed engagement with one another for a component may be, for example, in the form of tabs on the top surface that engage openings in the body portion. Such engagement may be made with the understanding that the top surface and the body portion of each component is not intended to be separated. Otherwise, the top surface and the body portion may be formed as a monolith with no clear separation between the two portions.

After transport of the products is complete, the components of the coupling system 10 are disengaged from one another as described hereinabove. Then the components of the coupling system 10 may be removed from their respective product or may remain on the product until further transport is needed. In some example embodiments, where it is contemplated that the components be removed from the product for use of the product, the components are decoupled as described hereinabove. At that point, it may be desirable to have a way to prevent loss of the components if separated from the product. To that end, in some example embodiments, a tether between the components of the coupling system 10 and the product may be utilized to ensure that the components are not lost. Otherwise, other fasteners such as magnets, snaps, etc., may be used. Where there is a transport container for the product, the transport container may include a pocket or pouch to place the components when not in use.

Many modifications and other embodiments of the disclosure set forth herein will come to mind to one skilled in the art to which the disclosure pertains having the benefit of the teachings presented in the foregoing description and the associated figures. Therefore, it is to be understood that the disclosure is not to be limited to the specific embodiments disclosed and that modifications and other embodiments are intended to be included within the scope of the appended claims. Moreover, although the foregoing description and the associated figures describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A coupling system, the system comprising:
a first component comprising a first top surface and a first body portion defined by a body wall having two opposing sides and two opposing ends and extending from the first top surface to a first bottom surface opposing the first top surface, wherein a first channel is formed through the two opposing ends of the body wall of the first body portion and between the first top surface and the first bottom surface, the first component comprising a first coupling mechanism;
a second component comprising a second top surface and a second body portion defined by a body wall having two opposing sides and two opposing ends and extending from the second top surface to a second bottom surface opposing the second top surface, wherein a second channel is formed through the two opposing ends of the body wall of the second body portion and between the second top surface and the second bottom surface, the second component comprising a second coupling mechanism complementary to the first coupling mechanism;
wherein the first component is coupleable with a first product receivable in the first channel and the second component is coupleable with a second product receivable in the second channel, the first component and the second component being brought into removable engagement by coupling the first and second coupling mechanisms together so as to enable the first and second products to be transported together as a unit.

2. The system of claim 1, wherein the first coupling mechanism comprises a first magnet arranged within the first body portion and adjacent to the first top surface, and the second coupling mechanism comprises a second magnet arranged within the second body portion and adjacent to the second top surface, such that the first coupling mechanism and the second coupling mechanism are brought into removable engagement by magnetically coupling the first magnet of the first coupling mechanism and the second magnet of the second coupling mechanism so as to enable the first and second products to be transported together as the unit.

3. The system of claim 2, wherein the first coupling mechanism further comprises a first protrusion defining a first central axis and extending from the first top surface to a first protrusion surface with a circumferentially extending side wall arranged between the first top surface and the first protrusion surface, the first protrusion defining a cavity having an a extending radially outwardly from the first central axis and through a portion of the side wall and a portion of the first protrusion surface, the first magnet being coaxially aligned in the first body portion of the first component with the first central axis of the first protrusion and with a first polarity facing the first top surface,
wherein the second coupling mechanism further comprises a second protrusion defining a second central axis and extending from the second top surface to a second protrusion surface with a circumferentially extending side wall arranged between the second top surface and the second protrusion surface, the magnet of the second polarity being coaxially aligned in the second body portion of the second component with the second central axis of the second protrusion and with a second polarity opposite to the first polarity facing second top surface, and
wherein the first component and the second component are brought into removable engagement by inserting the second protrusion into the opening of the cavity defined by the first protrusion and magnetically coupling the first magnet of the first coupling mechanism and the second magnet of the second coupling mechanism to thereby magnetically and mechanically couple the first component and the second component so as to enable the first and second products to be transported together as the unit together.

4. The system of claim 3, wherein the second protrusion comprises a shoulder radially extending outwardly from the second central axis about the circumferentially extending side wall and arranged in between the second top surface and the second protrusion surface.

5. The system of claim 4, wherein a width of the opening extending through the portion of the first protrusion surface is narrower than a width of the opening extending through the portion of the side wall such that a lip is formed on the first protrusion surface that is narrower in width than a width of the shoulder of the second protrusion, such that when the second protrusion is inserted into the opening of the cavity defined by the first protrusion, the second protrusion is retained by contact between the shoulder and the lip.

6. The system of claim 4, wherein the second protrusion surface has a width greater than a width of the circumferentially extending side wall of the second protrusion, the width of the second protrusion surface and a width of the shoulder being substantially the same or different.

7. The system of claim 3, wherein the second protrusion surface contacts the first top surface of the first component and the first protrusion surface contacts the second top surface of the second component when the first component and the second component are brought into removable engagement.

8. The system of claim 1, wherein the first product is a foldable chair and the second product is a foldable chair, each of the foldable chairs comprising a frame having a portion with a width that is smaller than a width of the first and second channels so that the portion of the frame of each foldable chair is receivable in one of the first and second channels.

9. The system of claim 1, wherein the first bottom surface of the first component is formed by first and second bottom regions arranged opposed to one another on a respective one of the opposing sides of the body wall and separated by an area open to the first channel, and
wherein the second bottom surface of the second component is formed by first and second bottom regions arranged opposed to one another on a respective one of the opposing sides of the body wall and separated by an area open to the second channel.

10. The system of claim 9, wherein a first end of the two opposing ends of the first channel is defined by a first interior surface of the body wall that is arranged in a plane between the first top surface and the first bottom surface of the first component, a second interior surface of the body wall that is arranged opposed to the first interior surface and in a plane between the first bottom surface and the first interior surface of the first component, and an interior side wall arranged interior to the side of the body wall from which the first bottom portion of the first bottom surface is formed, and a second end of the two opposing ends of the first channel being defined by the first interior surface, the second interior surface, and an interior side wall arranged interior to the side of the body wall from which the second bottom portion of the first bottom surface is formed, and
wherein a first end of the two opposing ends of the second channel is defined by a first interior surface of the body wall that is arranged in a plane between the second top surface and the second bottom surface of the second component, a second interior surface of the body wall that is arranged opposed to the first interior surface and in a plane between the second bottom surface and the first interior surface of the second component, and an interior side wall arranged interior to the side of the body wall from which the second bottom portion of the second bottom surface is formed, and a second end of the two opposing ends of the second channel being defined by the first interior surface, the second interior surface, and an interior side wall arranged interior to the side of the body wall from which the second bottom portion of the second bottom surface is formed.

11. The system of claim 10, wherein a portion of the first product is received in the area open to the first channel on the first component, such that the first component is angled between about 0 degrees and about 90 degrees relative to the portion of the first product to allow for rotation of the first component between about 0 degrees and about 90 degrees relative to the portion of the first product so that the portion of the first product is received in the first channel, and
wherein a portion of the second product is received in the area open to the second channel on the second component, such that the second component is angled between about 0 degrees and about 90 degrees relative to the portion of the second product to allow for rotation of the second component between about 0 degrees and about 90 degrees relative to the portion of the second product so that the portion of the second product is received in the second channel.

12. The system of claim 11, wherein each of the first and second bottom portions of each of the first and second components comprises a retaining clip formed on the respective second interior surface and that extends toward the respective first interior surface to form a convex surface relative to the second interior surface so as to retain the respective portions of the first and second products within the respective first channel or second channel.

13. The system of claim 11, wherein the first and second bottom regions of each of the first and second components are each formed as a right triangle with a 90 degree angle between an intersection of one of the two opposing ends and an adjacent one of the two opposing sides with a 45 degree angle relative to the respective side of the body wall from which the respective first and second bottom regions extend such that the first component is angled at about 45 degrees relative to the portion of the first product to allow for rotation of the first component about 45 degrees relative to the portion of the first product and the second component is angled at about 45 degrees relative to the portion of the second product to allow for rotation of the second component about 45 degrees relative to the portion of the second product.

14. The system of claim 10, wherein the first interior surface and the second interior surface of each of the first and second component are planar and the interior side walls of each of the first and second components are curved to form a U-shaped cross-section of each of the first and second channels.

15. The system of claim 1, wherein the first and second components are injection molded.

16. The system of claim 1, wherein the first and second components are made of plastic.

17. The system of claim 1, wherein the first and second coupling mechanisms are removably arranged on the first and second top surfaces of the respective first component and the second component.

18. The system of claim 1, further comprising third and fourth components identical to a respective one of the first component and the second component, such that the first and third components are coupleable with the first product and the second and fourth components are coupleable with the second product, the first component and the second component and the third component and the fourth component being brought into removable engagement by coupling respective coupling mechanisms so as to enable the first and second products to be transported together as a unit.

19. The system of claim 1, wherein the respective first and second top surfaces and the first and second body portions of each of the first component and the second component are fixedly engaged with one another as separate components or formed as an integral unit.

20. The system of claim 1, wherein the two opposing sides of the first and second components are longer in length than a length of the respective two opposing ends of the first and second components.
